(19) United States
(12) Patent Application Publication
(10) Pub. No.: US 2003/0010938 A1
(43) Pub. Date: Jan. 16, 2003

(54) Double-chamber container for transporting or storing radioactive materials

(76) Inventors: Laurent Michels, Maisons-Lafitte (FR); Laurent Milet, Paris (FR)

Correspondence Address: PEARNE & GORDON LLP, 526 SUPERIOR AVENUE EAST, SUITE 1200, CLEVELAND, OH, 44114-1484, US

(21) Appl. No.: 10/204,774

(22) PCT Filed: Feb. 23, 2001
(86) PCT No.: PCT/FR01/00534

(30) Foreign Application Priority Data
Feb. 24, 2000 (FR) 00/02314

(51) Int. Cl. G21F 5/00

(52) U.S. Cl. 250/507.1

(57) ABSTRACT

The invention concerns a container for transporting or storing radioactive materials comprising two separate confinement chambers, nested one in the other. The outer confinement chamber comprises at least an inside part of a body (10), a lid (12) and sealing members (16) interposed between them. The inner confinement chamber comprises a container (18) a plug (22) and sealing members (24) interposed between them. A flange (18b) of the container is supported against a shoulder (20) of the body (10). The plug (22) is pressed against the flange (18b) by fixing members (28, 30) advantageously anchored in the body (10).

Un conteneur destiné au transport ou au stockage de matiéres radioactives comprend deux enceintes de confinement distinctes, placéplacées l'une dans l'autre. L'enceinte de confinement extérieure comprend au moins une partie intérieure d'un corps (10), un couvercle (12) et des organes d'étanchéité (16) interposé entre eux. L'enceinte de confinement intérieure comprend un récipient (18), un bouchon (22) et des organes d'étanchéité (24) interposés entre eux. Une bride (18b) du récipient (18) est en appui contre un épaulement (20) du corps (10). Le bouchon (22) est pressé contre la bride (18b) par des organes de fixation (28, 30) avantageusement ancrés dans le corps (10).

### TECHNICAL FIELD

This invention concerns a container for use in the transport or storage of radioactive materials, such as nuclear reactor fuel elements, containing or not containing fissile materials.

### BACKGROUND OF THE INVENTION

Existing containers used for the storage or transport of radioactive materials consist of a hollow body, generally of a cylindrical or parallel pipe shape. This hollow body is normally equipped with anti-shock devices, usually at the ends as well as handling devices such as ears or trunnions. Contained within is a closed cavity used to contain the radioactive material. More precisely, the radioactive materials are usually shipped in a series of vessels, called “basket” or “internal fitting” designed to fit within the cavity bounded by the hollow body.

To allow the insertion and removal of radioactive materials and their containers, the hollow body of the container comprises, at least at one of the ends, an opening that provides access to the cavity. Under normal conditions of transport or storage, this opening is capped with a closure system such as a bolted cover. Sealing arrangements installed between the body and the cover ensure that the cover is leakproof. Those sealing arrangements usually consist of one or several flexible or metallic seals.

Certain current containers consist of a solid block body with a thick metal shell assembly.

Other current containers employ a structure having several layers. Thus, the body of the container may well consist of a metal outer shell and an inner metal shell between which is inserted a neutron absorption material. In this case, the ends of the two metal shells are welded respectively to a metal plate at the base and a heavy metal flange at the end where the opening is located. These metal assemblies provide protection against gamma radiation, whereas the neutron absorption materials provide a means of absorbing neutrons.

In a container designed to store or transport radioactive materials, the “confinement vessel/jacket” is defined as the assembly of parts that bound the closed cavity in which are held the radioactive materials and their storage and transport packaging arrangements, and which are likely to be in direct contact with the particles emitted by the said materials.

Irrespective of the structure of the body of the current containers, they always comprise a single confinement vessel.

In the case of a solid block body, the confinement vessel comprises the said body, the associated closure device, as well as the related sealing arrangements that are placed between the body and the closure device. All these items thus provide sufficient mechanical strength to maintain the confinement in the event of an accidental shock.

When the body has a structure made from several layers, the confinement vessel comprises the internal metal shell, the flange and the base of the said body, the lid and the sealing arrangement providing the interface between the flange and the lid. The energy produced by an accidental shock is thus absorbed by deformation of the outer shell of the body and the neutron absorbing material, which enables the sealing integrity of the most fragile part of the body i.e. the inner metal shell, to be maintained. The other items of the confinement vessel have adequate mechanical strength to maintain confinement in the event of an accidental shock.

Generally speaking, containers destined for use in transport and storage of radioactive materials must comply simultaneously with several constraints created by the nature of the substances they contain.

A first constraint, which is common to all nuclear materials, is the need to ensure effective confinement of the materials. In other words, the containers must be designed to prevent, as far as possible, the release into the atmosphere of radioactive particles, for example in the form of gasses or aerosols.

In current containers, this function is provided by the single confinement vessel. It must be noted however that having just a single vessel by nature will not provide a means of total confinement. This is why the regulations in force set an allowable level of releases of radioactive particles into the atmosphere under normal storage or transportation conditions and also under accident conditions.

Another constraint to which all radioactive transport or storage containers must comply is the avoidance of achieving criticality when the materials placed in containers are of a fissile nature and liable to provoke a chain reaction, such as materials containing large quantities of plutonium. In other words, a container that is likely to be used for fissile radioactive material must be designed to prevent an uncontrolled release of neutrons from the material. Without such protection, a runaway chain reaction could produce serious consequences for anyone close to the container. In effect, they could be exposed to neutron radiation produced spontaneously and at high dose levels.

In practice, the risk of criticality can be prevented by employing special containers within the vessels designed to hold fissile material. In particular, these special containers have very high mechanical strength in order to maintain under all circumstances the physical separation of fissile materials, which could result in increased neutron release following an accident such as a dropped container.

The prevention of the risk of criticality is often provided by the addition of neutron absorbing materials within the structures of the vessels, for example in the form of rods, plates etc., containing a neutron absorbing material such as boron or cadmium. Furthermore because neutron absorbing materials are expensive, this makes the design and manufacture of vessels very complicated. In effect, these materials have to act as neutron absorbers as well as providing structural strength in a small volume, in order to prevent the container size and weight from growing and thus reducing the amount of radioactive material that may be transported.

These disadvantages are made worse because it is difficult to accurately predict the mechanical characteristics of the fissile materials to be placed in the container. In fact, the materials placed in the container are, for example, fuel elements from nuclear reactors which have complex structures and complicated vibrational characteristics. This leads to the need to further strengthen the mechanical strength characteristics of the materials used in the construction of the containers, as well as the quantities of neutron absorbing materials.

In current containers having a single confinement vessel, the safety regulations require the possible ingress of water to be also taken into account in the event of an accident to avoid the risk of criticality. In effect, if the radioactive fissile materials are mixed with water, the production of neutrons is hugely amplified because of the hydrogen content of the water. If the ingress of water results from an accident such as dropping a container, this phenomenon is made worse if the fissile material is damaged. The risks of accidental criticality are thus potentially increased. This requires a further strengthening of the stringent preventive measures described earlier, with the result that the costs of design and production of the containers increase.

In current containers, the sealing arrangements fitted between the body of the container and the lid represent weak points where the design is of the single confinement vessel type. In effect, the sealing properties of the seals may be altered especially under an accidental shock situation or in the event of a fire.

To overcome this problem, it is usual to fit certain containers with several lids, one on top of the other, with each lid having its own sealing arrangement. Such a design is described in particular in documents FR-A-2 448 766 and FR-A-2 478 862. A check on the sealing of the seals of one lid or between two successive lids can be carried out using passageways that run between the spaces between the seals to be checked. To perform these checks, the passageways are connected to measuring instruments able to make the leak proof tests by using pressure tests or by the detection of trace gasses introduced into the confinement vessel of the container.

Despite the improvement in sealing which results from the use of several lids together with the associated sealing arrangements, the containers still remain of the single vessel containment design. Consequently, the level of confinement provided is only as good as the level of sealing provided by this single vessel, especially where the body of the container is concerned. Also, the design of the fittings within the container must always take account of the ingress of water into the container in order to avoid the risk of criticality.

### DESCRIPTION OF THE INVENTION

The purpose of the invention is as a container for the transport or storage of radioactive materials for which the unique design provides in a very simple way two complete confinement vessels, one inside the other, by providing total redundancy of the confinement and, consequently, by ignoring the ingress of water into the container when designing the internal fittings, thus avoiding the risk of criticality in the event of an accident.

In accordance with the invention, this outcome is achieved using a container for the transport or storage of radioactive materials, which comprises a body fitted with at least one flange at the end where the opening is located, a lid for the said opening in the body, primary sealing arrangements between the lid and the said flange at the end of the body, and the primary method of attaching the lid to the said flange at the end of the body, capable of compressing the primary sealing arrangements, such that at least one internal part of the body, the lid and the primary sealing arrangements form an outer confinement vessel assembly, the said container being characterised in that the said flange at the end of the body comprises, inside the outer confinement vessel, at least one primary shoulder capable of acting as a support for an end flange of a flask, bounding a flask opening, a cap being provided in order to close the said opening of the flask, secondary sealing arrangements being fitted between the cap and the flange at the end of the flask, and secondary fixing arrangements being used to compress the secondary sealing arrangements between the cap and the flask end flange, such that the flask, the cap and the secondary sealing arrangements form a removable inner confinement vessel assembly, different from the outer confinement vessel, and in which the cap is able to be forced against a second shoulder formed in the body end flange.

In accordance with a first embodiment of the invention, the secondary fixing arrangements comprise a ring, able to be pressed against a face of the cap on the side of the lid, and the ring fixing arrangements on a third shoulder formed in the body end flange.

In accordance with a second embodiment of the invention, the secondary fixing arrangements consist of fittings for the cap on the second shoulder formed in the body end flange.

Beneficially, the third sealing arrangements are fitted between the cap and the secondary shoulder formed in the body end flange. This characteristic in particular provides the advantage of a layout similar to that of a container fitted with two lids, when the container in accordance with the invention is used without the flask.

Fourth sealing arrangements may also be installed between an outer surface on the perimeter of the end flange of the flask and an inner peripheral surface in the body end flange.

Preferably, the flask will include a sealed base at the opposite end to the end flange.

The lid and at least the said internal part of the body are preferably manufactured using a material selected from the range including cast iron, iron alloys, stainless steels and carbon steels.

On the other hand, the cap and the flask are best made using a material selected from the range including stainless steels, carbon steels, aluminium and aluminium alloys.

Moreover, the wall of the flask should preferably have a thickness of between 0.3 cm and 5 cm.

### BRIEF DESCRIPTION OF THE DRAWINGS

There follows, for example purposes, non exhaustive examples of embodiments of a container in accordance with the invention, by referring to the annexed drawings in which

FIG. 1 is a vertical half section which represents diagrammatically a part of a transport or storage container for radioactive materials in accordance with a first embodiment of the invention ;

FIG. 2 is a vertical section view showing a magnified view of a part of the container in FIG. 1 ;

FIG. 3 is a similar section view to that in FIG. 2 showing another embodiment of the invention and

FIG. 4 is a similar section to that of FIG. 1 showing another embodiment of the invention.

### DETAILED DESCRIPTION OF SEVERAL EMBODIMENTS OF THE INVENTION

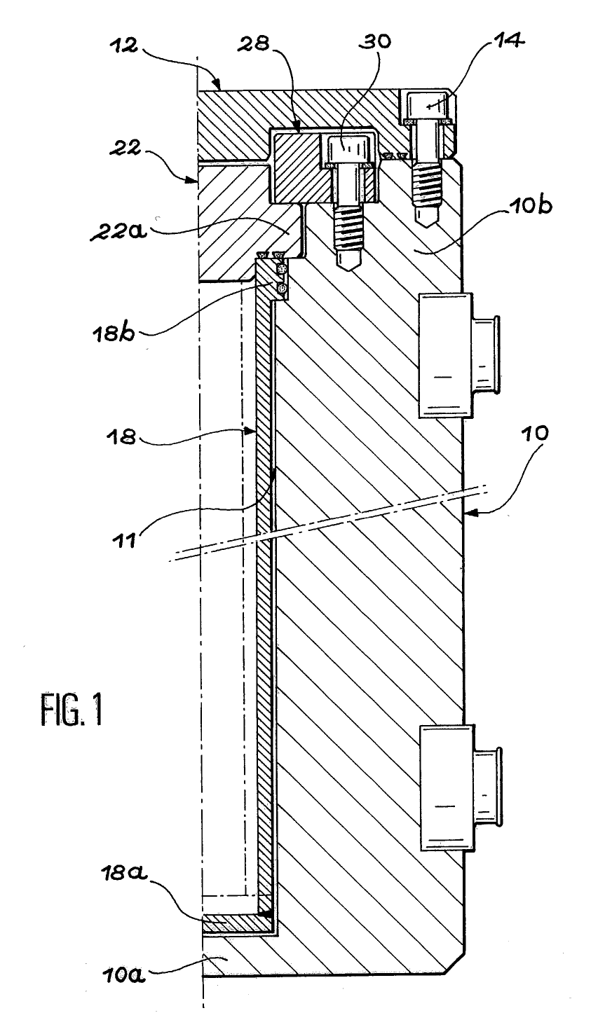

FIG. 1 shows a part of a container in accordance with a first embodiment of the invention.

In this embodiment the container comprises a main body 10, made from cast iron, iron alloy, carbon steel or stainless steel. The main body 10, is cylindrical or parallel pipe in shape for example, depending upon the radioactive material that is to be loaded into the container. The main body 10 is hollow and forms the inner boundary of a cavity 11. This cavity is closed at one of its ends by a thick base 10a which is an integral part of the body 10 (in the case where the body 10 is made of steel, the base 10a may preferably be welded to the inside of the shell).

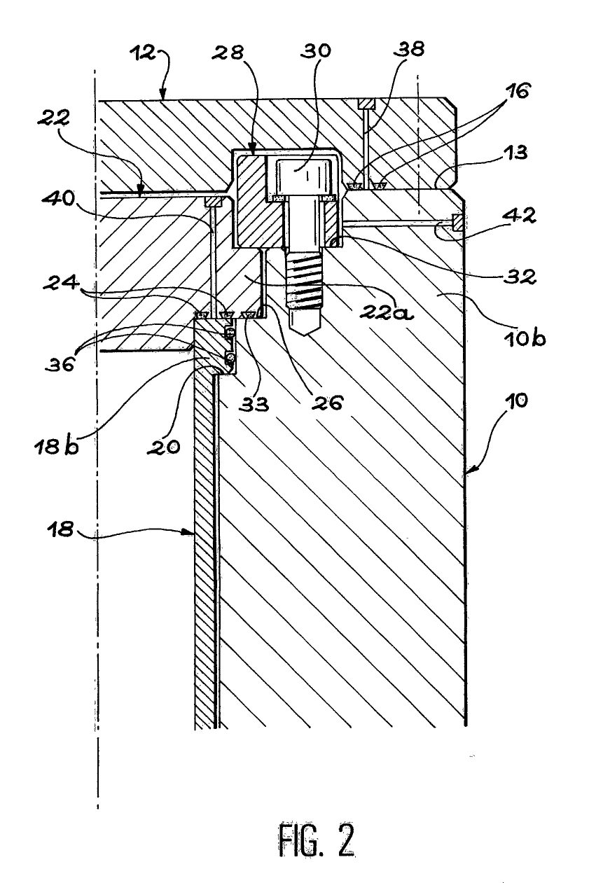

At the opposite end of the main body 10 of the container, at the top in FIG. 1, is an end flange 10b, which forms the boundary for an opening. This opening in the body 10 is closed with the lid 12. More exactly, the lid 12 is designed to be fitted onto the face of the end 13 (FIG. 2) of the flange 10b, using a primary fixing arrangement such as screws 14. Thus the lid 12 provides a closure for the opening bounded by the end flange 10b of the body 10. The lid 12 can be made from the same material as the body 10.

The primary sealing arrangements are fitted between the adjacent faces of the lid 12 and the body 10, in order that the assembly constituted by the body 10 and the lid 12 forms an outer confinement vessel for the container. These primary sealing arrangements are comprised of at least a circular seal such as a flexible seal or a metal seal located at the interface between the body and the lid. In the first embodiment of the invention illustrated in more detail in FIG. 2, these primary sealing arrangements are comprised of two concentric sealing rings 16 (i.e. parallel with each other), located in grooves machined in the face of the lid 12 and facing the body 10 in order to provide a leak proof seal with the end face 13 of the body 10 end flange 10b, onto which the lid fits.

In accordance with the invention, the outer confinement vessel thus formed entirely surrounds a separate inner confinement vessel placed in a removable fashion within the outer confinement vessel.

The removable inner confinement vessel comprises a flask 18 designed to be placed within the cavity 11 formed by the main body 10. The flask 18 comprises a metal shell in the shape of a tube or parallel pipe (depending on the shape of the body 10), closed by a base 18a welded in place at its end and inserted against the base 10a of the body 10. The flask 18 is for example made from stainless steel, carbon steel, aluminium or aluminium alloy.

The other end of the flask 18 comprises an end flange 18b, which forms the boundary for an opening. This end flange 18b extends upwards in order to make contact with a primary shoulder 20 machined inside the end flange 10b of the body 10.

The internal confinement vessel of the container shown in FIGS. 1 and 2 also comprises a closure cap 22, designed to provide a leak proof seal with the opening formed by the end flange 18b of the flask 18. This cap 22 is manufactured from the same materials as the flask 18. It includes on its outer perimeter a flange 22a that is supported on the end face of the end flange 18b of the flask 18.

The secondary sealing arrangements are located between the flange 22a of the cap and the end flange 18b of the flask. As with the primary sealing arrangements, the secondary sealing arrangements comprise at least one circular sealing seal such as a flexible seal or a metal seal. In the embodiment shown in FIGS. 1 and 2, the secondary sealing arrangements comprise two concentric sealing rings 24 located in grooves machined on the lower face of the flange 22a of the cap 22 to provide a leak proof seal on the upper face of the flange 18b of the flask 18.

In the embodiment shown in FIGS. 1 and 2, the inner face of the flange 22a of the cap 22 is also in contact with a secondary shoulder 26 machined on the inside of the end flange 10b of the body 10 of the container.

Moreover, secondary fixing arrangements can be provided in such a way as to exert a contact compression force between the flange 22a of the cap and the flange 18b of the flask, in order to ensure leak proof sealing of the seals 24 and thus the inner confinement vessel of the container.

In the embodiment shown in FIGS. 1 and 2, the secondary fixing arrangements ensure moreover the attachment of the cap 22 to the flange 10b of the body 10 of the container, and similarly they apply a compression force between the cap flange 22a and the shoulder 26.

In the first embodiment of the invention, the secondary fixing arrangements are comprised of a ring 28, fixed using fixings 30 such as screws, on a third shoulder 32 machined in the end flange 10b of the body 10. On its inner diameter, the lower face of the ring 28 presses against the upper face of the flange 22a of the cap 22. Consequently, the cap 22 is maintained in a leak proof seal against the top face of the flange 18b of the flask 18. The leak proof seals 24 are thus compressed, such that the flask 18, the cap 22 and the secondary sealing arrangements form the removable inner confinement vessel assembly of the container.

Beneficially, although optional, the third sealing arrangements may be used between the lower face of the flange 22a of the cap 22 and the secondary shoulder 26 formed in the end flange 10b of the body 10. These sealing arrangements beneficially comprise at least one sealing ring 33 such as a flexible elastic joint or a metallic seal, set into a groove machined into the cap 22, in order to provide a leak proof seal against the shoulder 26.

Equally beneficially, although not essential, a fourth sealing arrangement is fitted between the outer peripheral surface of the flange 18b of the flask 18 and the peripheral inner surface of the end flange 10b of the body 10, between the shoulders 20 and 26. This fourth sealing arrangement comprises at least one circular leak proof seal such as a flexible elastic seal or a metallic seal. In the example of the embodiment shown in FIG. 2, the fourth sealing arrangement comprises two leak proof seals 36 inserted into annular grooves machined into the outer peripheral surface of the flange 18b, in order to form a leak proof seal on the inner peripheral surface of the end flange 10b of the body 10 between the shoulders 20 and 26.

The fourth sealing arrangement provided by the seals 36 in FIG. 2 is used to prevent the ingress of contaminated water into the space between the flask 18 and the body 10 of the container, especially when the loading of fuel elements into the inner flask 18 is conducted under water, after removal of the lid 12 and the cap 22.

As has been shown in FIG. 2, a passageway 38 passes through the lid 12, in the direction of its thickness, to emerge in the space between the two, leak proof seals 16 on the lower face of the lid. Similarly, a passageway 40 passes through the cap 22, in the direction of its thickness, and emerges into the space between the leak proof seals 24, on the lower face of the cap. Moreover, in the embodiment described, a passageway 42 passes radially through the end flange 10b of the body 10, to emerge in the space between the lid 12 and the cap 22, for example above the shoulder 32.

Using a well-known technique, the passageway 38 may be connected to an external leak detection system, in order to check that the seals 16 are leak proof. Similarly the passageway 40 may be connected to an external leak detection system, in order to check that the seals 24 are leak proof before fitting the lid 12. Finally, the passageway 42 may be used to check the space between the lid 12 and the cap 22, and in particular the seal 33 when fitted. The passageway 42 can also be used to take a sample or inject an inert gas into the space, depending upon the techniques involved and those skilled in the art.

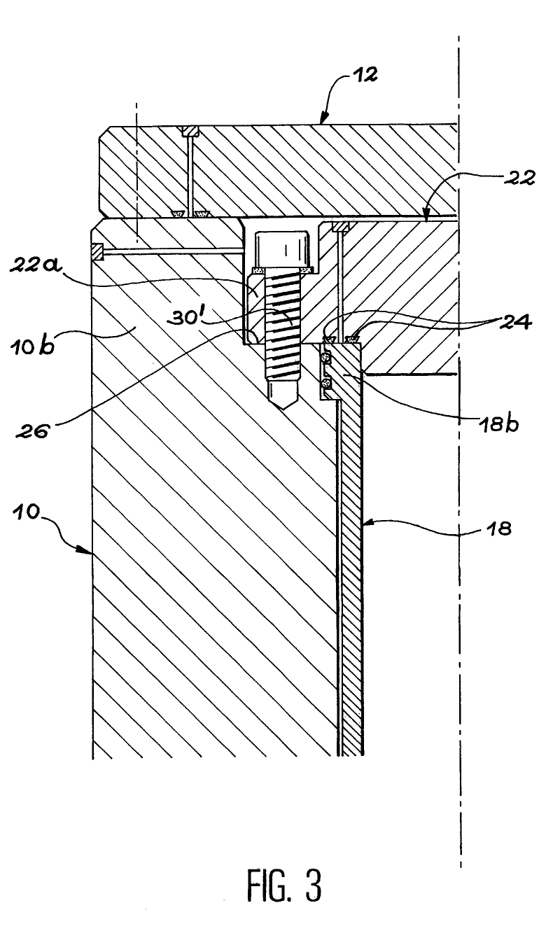

In FIG. 3, a second embodiment of the invention has been shown diagramatically.

This embodiment essentially differs from the previous one by the design of the fixing arrangements used to tighten the cap 22 both to the end face of the flange 18b of the flask 18 and to the shoulder 26 machined into the end flange 10b of the body 10. In this case the ring 28 is deleted and the diameter of the cap 22 as well as the width of the shoulder 26 are increased. These characteristics allow the flange 22a of the cap 22 to be attached directly to the shoulder 26 using fixing arrangements such as screws 30′. Thus the leak proof seals 24 between the flange 22a of the cap and the upper face of the flask flange 18b are compressed.

In another embodiment, which is not shown, the cap 22 is fitted directly to the end flange 18b of the flask 18, using fixtures such as screws. In this case two options are possible.

In accordance with a first option, the shoulders 26 and 32 are deleted and the thickness of the flange 18b is increased.

In accordance with a second option, only the shoulder 26 is deleted. However, the ring 28 and shoulder 32 are maintained. This option advantageously allows the separation between the inner confinement vessel and the outer confinement vessel to be maintained and thus avoids it hitting the lid 12 and causing damage to it and the seals in the event of a shock.

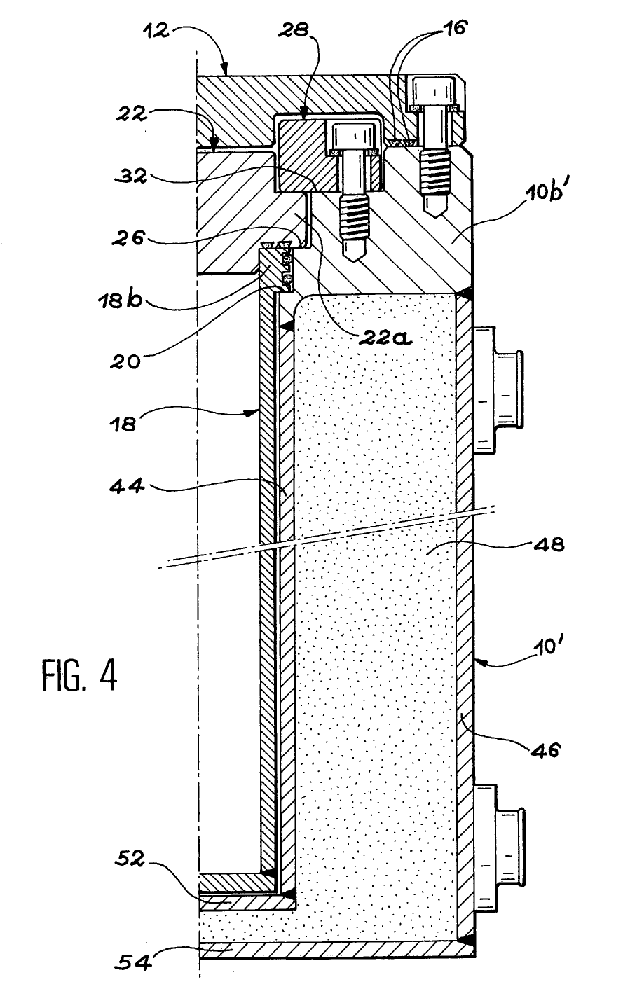

Another embodiment of the invention, illustrated in FIG. 4, essentially differs from the earlier described embodiments by the structure of the container body. In effect, instead of using a solid thick shell, the body of the container takes the form of a multi-layer structure.

More precisely the body of the container referred to in this case by the reference 10′ compresses an inner metal shell 44, an outer metal shell 46, as well as an intermediate filler material 48. The inner 44 and outer 46 metal shells are made for example from cast iron, iron alloy, stainless steel or carbon steel. The filler material 48 is a softer material, such as lead, capable of stopping gamma radiation, or a plaster-type material, resin or other, able to absorb neutrons and provide thermal insulation, or even a mixture of all these materials.

The inner 44 and outer 46 shells are welded to the metal flange forming the end flange 10b′ of the body 10′ of the container. The flange 10b′ is made from the same material as the shells 44 and 46. It is machined on the upper face as well as the inner peripheral face, in the same way as the earlier embodiments in order to receive the lid 12, the cap 22 and if used, the ring 28.

Thus, in the embodiment shown at FIG. 4, for which the cap 22 fixing arrangements are identical to those used in the first embodiment described earlier, three shoulders 20, 26 and 32 are machined on the inner diameter of the flange 10b′, in order to support respectively the flange 18b of the flask 18, the peripheral flange 22a of the cap 22 and the ring 28.

At the other end opposite the flange 10b′, the inner shell 44 and the outer shell 46 are closed and sealed respectively by an inner base 52 and outer base 54. The bases 52 and 54 are welded respectively to the shells 44 and 46. As shown in FIG. 4, the material 48 is also used to fill the space between bases 52 and 54.

In the embodiment shown in FIG. 4, the outer confinement vessel of the container is comprised of the inner shell 44 with its base 52, the end flange 10b′ of the body 10′, the lid 12 and the circular leak proof seals 16 located at the interface between the top face of the flange 10b′ and the mating face of the lid 12.

In accordance with the invention and as shown in the different embodiments which have just been described, the container comprises two different confinement vessels, one fitted inside the other. This configuration ensures a level of redundancy of the confinement of the radioactive material and ensures there is no ingress of water into the inner container, even under the most severe hypothetical accident conditions of a dropped container or a fire. Consequently, the size of the internal structures of the container as well as the amounts of neutron absorbing materials built into the structures may be greatly reduced when compared with current containers. This is reflected in a lowering of the design and production costs of such a container.

Furthermore, in the different embodiments proposed, the installation of the inner confinement vessel, as well as the inner fittings, is simple to achieve. In particular, the flask 18 is located or introduced by simple compression of the peripheral part of the cap 22 against the inner shoulder 20 machined in the end flange 10b of the container body.

This characteristic enables the flask 18 to be inserted, whilst loaded with radioactive material and without its cap 22, within the body of the container using remote handling equipment. The operation is complete once the flange 18b of the flask 18 comes into contact with the shoulder 20. In other words, there is no requirement at this stage to use a locking arrangement such as screws. The staff performing the task are thus protected against contamination and radiation from radioactive materials loaded into the flask 18.

The operation that follows of placing the cap 22 onto the upper face of the flange 18b of the flask 18 and the shoulder 26 (in the embodiments shown), is equally a simple task and may also be performed remotely. Consequently, there is no requirement for the proximity of staff to the flask 18 whilst it remains unsealed in the open position.

When the operatives are required to attach the ring 28 to the end flange 10b of the body 10 using the screws 30, or to directly attach the cap 22 to this flange or the flask flange 18b, for example using the screws 30′, the flask 18 is already closed. The operatives are thus protected against internal contamination and radiation by the thickness of the cap 22 and the sealing arrangements provided by the seals 24.

A further advantage provided by the container in accordance with the invention concerns the interchangeability of the fittings of the inner confinement vessel. In effect in the case where a double confinement vessel system is not required and if it is intended to reduce the weight of the container thus inversing its capacity, the flask 18 can be easily removed. This is easily achieved either by removing the locking ring 28 and the cap 22 or by directly removing the latter. The flask 18 can then be easily extracted from the body of the container using the appropriate handling arrangement since the flask is simply resting on the shoulder 20.

Depending on the circumstances, the cap 22 can either be refitted or not. For the latter case, the container does not contain any of the inner confinement vessel parts. It can thus be used to transport larger quantities of less active or less fissile materials.

When the cap 22 is replaced after removal of the flask 18, the optional presence of the sealing ring 33 (FIG. 2) thus produces a single confinement vessel container, but having multiple confinement barriers, thanks to the closure arrangements. Thus all the advantages of a single confinement vessel are available, but with several closure devices of a prior art.

The ability to remove the flask 18 and the manner in which it is installed also allows on the other hand, an increase in the protection against radiation generated outside the container. In effect, it is easy to increase the thickness of the components used in the inner confinement vessel without the need to alter the machining of the container body, nor the attachment method used with the cap 22 of the flask 18. Thus the flask 18 and possibly the cap 22 may be replaced by a flask and a cap of different thicknesses, better suited to the transport of the radioactive materials. As an example, a flask 18 with an increased thickness has been shown by a chain dot line in FIG. 1. In practice, the thickness of the wall of the container 18 is generally between 0.3 cm and 5 cm.

Moreover, the embodiments described by reference to the figures allow the dimensions of the recesses machined in the end flange 10b of the container body to be reduced, in order to accept the components of the inner confinement vessel. In effect, the flange 18b of the flask 18 is simply compressed between the cap 22 and the shoulder 20 of the body 10, without any tightening arrangement in this area, such as screws that would require adequate space for their installation through the flange 18b and the shoulder 20. Consequently, the width of the flange 18b and that of the shoulder 20 may be reduced to a minimum, as the figures show.

The above described characteristics allow the proportional reduction of the thicknesses and external diameters of the shoulders such as 26 and 32 that accept respectively the cap 22 and maybe the ring 28 associated with the screws 30, in the embodiments described by reference to the figures.

By not removing excessive amounts of material from the outer confinement vessel, sufficient wall thicknesses are maintained to ensure the mechanical strength of the end flange 10b of the flask, to which are attached the closing devices. This characteristic is particularly useful in the event of accidental shocks, when the external confinement vessel is required to absorb the majority of the shock energy without detriment to the structure.

Naturally, the invention is not limited to the embodiments that have been described for example purposes. Thus, it is understood that it is possible to combine the embodiments shown respectively in FIGS. 3 and 4. On the other hand, the sealing arrangements described may take different forms whilst still respecting the framework of the invention. Thus, instead of being machined into the cap and the lid, the recesses for the seals can also be machined into the body of the container and the flask.

1. Container for the transport or storage of radioactive materials, comprising a body (10; 10′) equipped with at least one end flange (10b) around an opening, a lid (12) to close the said body opening, primary sealing arrangements (16) fitted between the lid (12) and the said end flange (10b) of the body, and the primary attachment arrangements (14) of the lid (12) on the said end flange of the body (10; 10′), able to compress the primary sealing arrangements (16), such that at least one internal part (10; 44, 52, 10b′) of the body, the lid (12) and the primary sealing arrangements (16) form an outer confinement vessel assembly, the said container being characterised in that the said end flange (10b) of the body (10; 10′) comprises, within the outer confinement vessel, at least one primary shoulder (20) able to provide support for the end flange (18b) of a flask (18), that bounds an opening in the flask, a cap (22) being used to close the said flask opening, secondary sealing arrangements (24) being fitted between the cap (22) and the flask (18) end flange (18b) and secondary attachment arrangements (28, 30; 30′) being used to compress the secondary sealing arrangements (24) between the cap (22) and the end flange (18b ) of the flask (18), in such a way that the flask (18), the cap (22) and the secondary sealing arrangements (24) form a separate inner removable confinement vessel assembly, and in which the cap (22) is in contact with a second shoulder (26) formed in the body end flange (10; 10′).

2. Container in accordance with claim 1, in which the secondary fixing arrangement comprises a ring (28) able to contact a face of the cap (22) facing the lid (12), and ring (28) fixing arrangements (30) on the third shoulder (32) formed in the end flange (10b ) of the body (10; 10′).

3. Container in accordance with claim 1, in which the secondary fixing arrangement comprises items (30′) for attaching the cap (22) to the second shoulder (26) formed in the end flange (10b) of the body (10; 10′).

4. Container as claimed in any of claims 1 to 3, in which the third sealing arrangement (33) is fitted between the cap (22) and the second shoulder (26) formed in the end flange (10b ) of the body (10; 10′).

5. Container as claimed in any of the preceding claims, in which the fourth sealing arrangement (36) is fitted between an outer peripheral surface of the end flange (18b) of the flask and an inner peripheral surface of the end flange (10b ) of the body (10; 10′).

6. Container as claimed in any of the preceding claims, in which the flask (18) comprises a sealed base (18a), at the opposite end to the end flange (18b).

7. Container as claimed in any of the preceding claims, in which the lid (12) and at least the said inner part (44) of the body (10; 10′) are manufactured from a material selected from a group comprising cast irons, iron alloys, stainless steels and carbon steels.

8. Container as claimed in any of the preceding claims in which the cap (22) and the flask (18) are manufactured from a material selected from a group comprising stainless steels, carbon steels, aluminium and aluminium alloys.

9. Container as claimed in any of the preceding claims, in which the flask (18) is built using a wall thickness of between 0,3 cm and 5 cm.
